(19) United States
(12) Patent Application Publication
(10) Pub. No.: US 2025/0008923 A1
(43) Pub. Date: Jan. 9, 2025

(54) HORSE LEG PROTECTOR

(71) Applicant: JONE SHOU INDUSTRIAL CO., LTD., NANTOU COUNTY (TW)

(72) Inventor: Chih Shun Chang, NANTOU COUNTY (TW)

(21) Appl. No.: 18/894,804

(22) Filed: Sep. 24, 2024

Related U.S. Application Data
(63) Continuation-in-part of application No. 18/080,876, filed on Dec. 14, 2022, now abandoned.

(30) Foreign Application Priority Data
Dec. 15, 2021 (TW) 110214931

(51) Int. Cl. A01K 13/00

(52) U.S. Cl. CPC A01K 13/007

(57) ABSTRACT

A horse leg protector comprising a protection body. At least two elastic slots formed on the protective surface corresponding to the posterior side of the metacarpal bone. At least three metacarpal guards formed on the protective surface and corresponding to the posterior side of the metacarpal bone, any two metacarpal guards are formed on the upper side and lower side of the elastic slot respectively, and the outer periphery of each metacarpal guard has a first slope and a second slope. The protection body is bent towards the direction of the protective surface, the slopes of each metacarpal guard facing the elastic slot gradually approach each other, the width of each elastic slot is gradually reduced by the compression of each metacarpal guard. This protector utilizes the combined action of elastic slots and multiple guards to offer maximum protection to the horse's leg while allowing for unrestricted movement.

### FIELD OF THE INVENTION

The present invention relates to a protector, and more particularly to a horse leg protector.

### BACKGROUND OF THE INVENTION

When a horse is running at high speed or jumping, the horse stretches out its front and rear legs in opposite directions. Sometimes when the rear legs lift forward and the front legs do not stretch forward, the rear legs may kick the front legs, causing an injury to the front legs.

In order to solve the aforementioned problem, the horse leg is wrapped with a protector to prevent an injury to the front leg when the front leg is kicked by the rear leg. Taiwan Patent Publication No. M564908 discloses a horse leg protector. The horse leg protector is in the shape of a cylinder extending along the length of the horse leg for wrapping part of the horse leg. However, in order to achieve the purpose of protection, a conventional horse leg protector is generally made of hard materials, such as hard plastics or metal plates, and a soft cushion as a lining is disposed on the inner side of the horse leg protector. Because the horse legs are not straight, the horse will bend its legs for running. When a horse wears a leg protector, if the leg protector is unable to be in close contact with the surface of the horse leg, it will cause discomfort and affect the smoothness of running.

### SUMMARY OF THE INVENTION

The primary objective of the present invention is to provide a perforated horse leg protector designed to be worn on a horse's leg. This protector utilizes the combined action of elastic slots and multiple guard to offer maximum protection to the horse's leg while allowing for unrestricted movement.

To achieve the aforementioned objective, the present invention provides a horse leg protector, comprising a protection body having a wearing surface facing the horse leg and a protective surface facing the external space. At least two elastic slots, formed on the protective surface corresponding to the posterior side of the metacarpal bone. At least three metacarpal guards, having a specific thickness and formed on the protective surface and corresponding to the posterior side of the metacarpal bone, any two metacarpal guards are formed on the upper side and lower side of the elastic slot respectively, and the outer periphery of each metacarpal guard has a first slope and a second slope.

The protection body is bent towards the direction of the protective surface, the slopes of each metacarpal guard facing the clastic slot gradually approach each other, the width of each elastic slot is gradually reduced by the compression of each metacarpal guard, and when the protection body is in the maximum bending state, the slopes of each metacarpal guard facing the elastic slot are in contact with each other.

### BRIEF DESCRIPTION OF THE DRAWINGS

FIG. 1 is a plan view of the present invention.

FIG. 2 is a side view of the present invention.

FIG. 3 is a schematic view of the present invention in use.

FIG. 4 is another schematic view of the present invention in use.

### DETAILED DESCRIPTION OF THE PREFERRED EMBODIMENTS

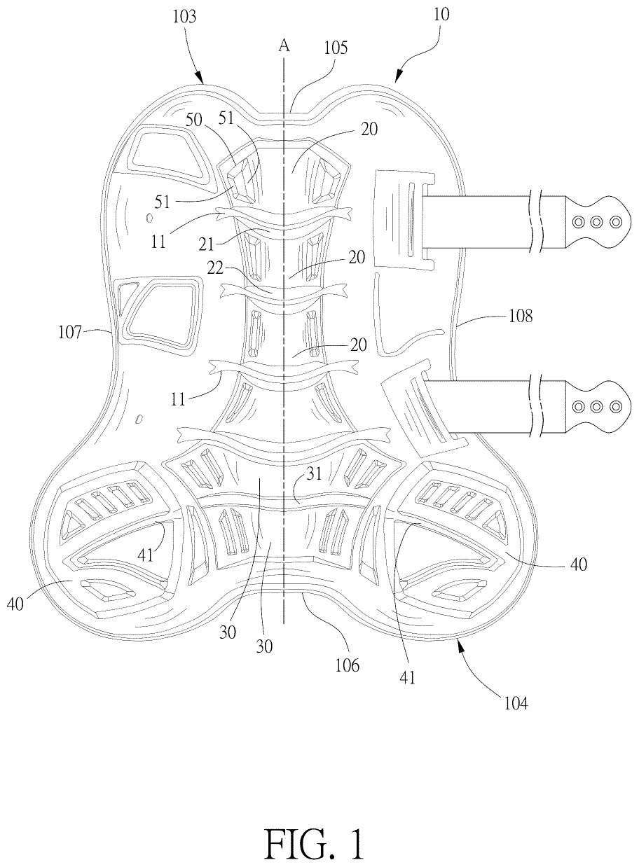

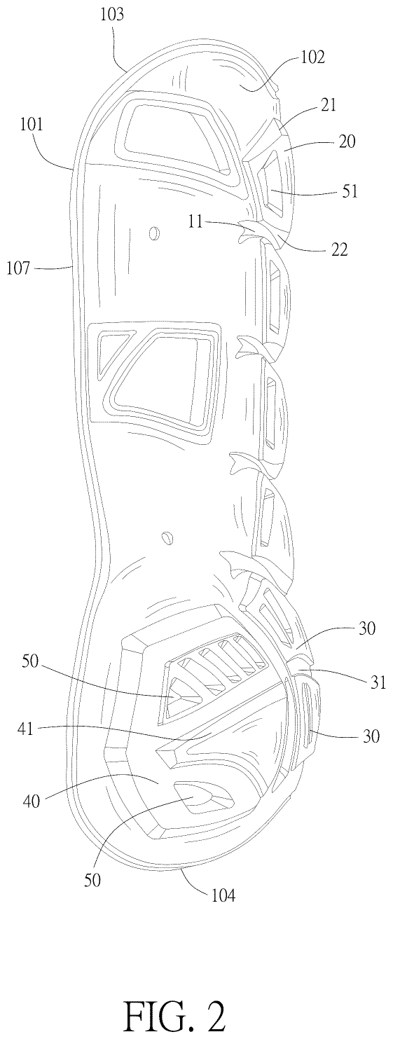

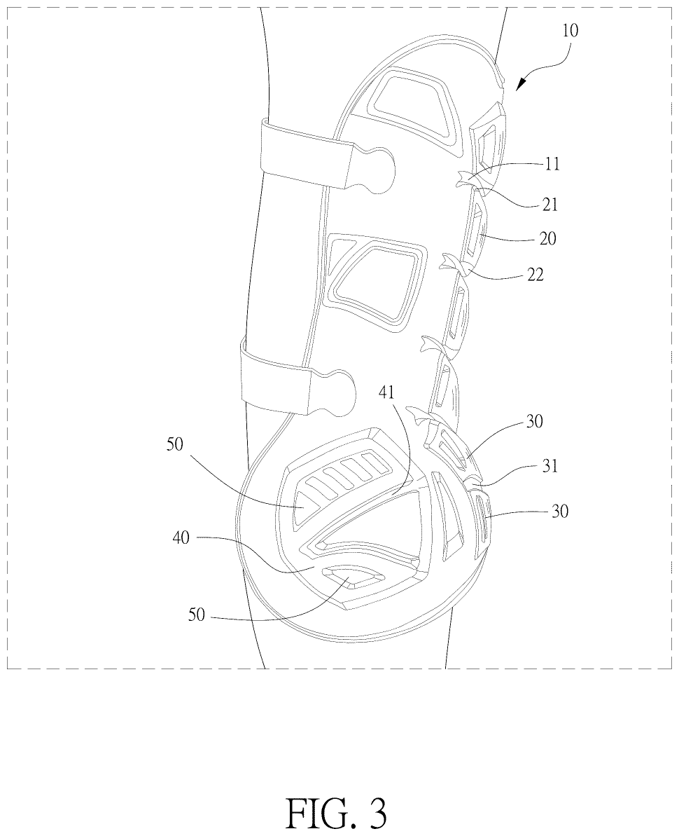

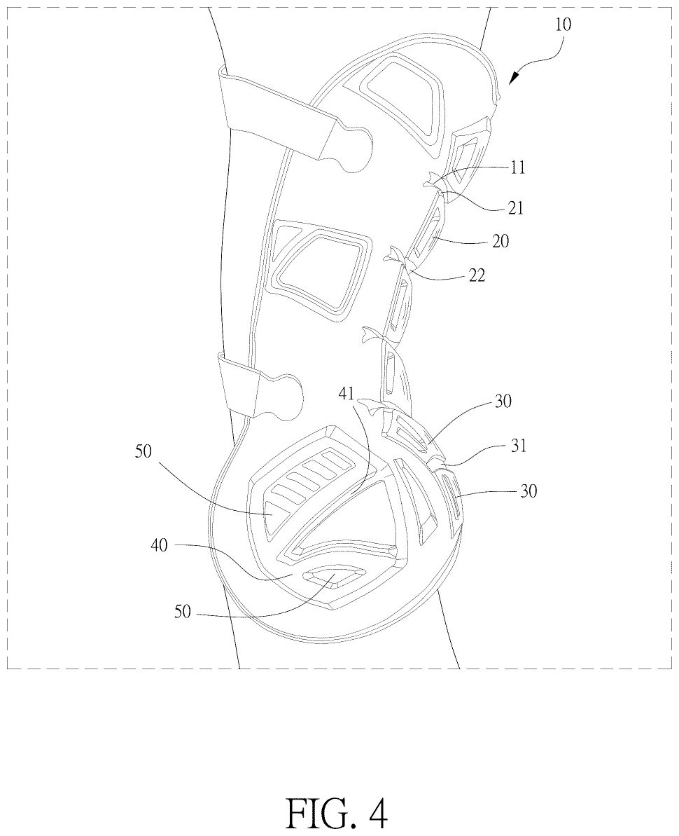

Referring to FIGS. 1-4, there is provided a horse leg protector according to the present invention, which comprises a protection body 10 and a plurality of elastic slots 11, wherein the protection body 10 is wrapped around the metacarpal bone and sesamoid bones of a horse leg, wherein: The protection body 10 has a wearing surface 101 facing the inside of the horse leg, and the opposite side of the wearing surface 101 is a protective surface 102 facing the external space, and a cushioning material can be added on the wearing surface 101 to improve wearing comfort, and the protective surface 102 is made of high-strength plastic and has excellent impact resistance. The upper side of the protection body 10 has a first short side 103, and the lower side of the protection body 10 has a second short side 104, the first short side 103 is inwardly recessed from the second short side 104 to form a first recess 105, and the first short side 103 on both sides of the first recess 105 forms a concave arc. The second short side 104 is inwardly recessed from the first short side 103 to form a second recess 106, and the second short side 104 on both sides of the second recess 106 forms a convex arc. The first recess 105 and the second recess 106 are connected to form an imaginary center line A parallel to the metacarpal bone of the horse leg. The protection body 10 has a first long side 107 and a second long side 108 on both sides respectively, and the first long side 107 and the second long side 108 are symmetrical to each other.

The protection body 10 has at least two elastic slots 11, each elastic slot 11 is formed on the protective surface 102 of the protection body 10 and corresponds to the posterior side of the metacarpal bone. Each elastic slot 11 is formed between the first short side 103 and the second short side 104, and the elastic slots 11 are arranged at intervals on the imaginary center line A. Both ends of each elastic slot 11 are closed and face the first long side 107 and the second long side 108, respectively. The closed end of each elastic slot 11 is bifurcated to form angular grooves, and the angular grooves are obliquely extended in different directions to form a dovetail shape. Each elastic slot 11 is continuously curved and is composed of at least two curved sections with opposite directions of curvature. The middle part of each elastic slot 11 is concave, and both ends are convex, and the radius of curvature and length of the concave part of the elastic slot 11 are larger than the radius of curvature and length of the convex part. In this embodiment, there are four elastic slots 11, and the length of each elastic slot 11 gradually changes from the first short side 103 to the second short side 104, and the elastic slot 11 closer to the first short side 103 and the second short side 104 has a longer length than the other elastic slots 11.

The protection body 10 has at least three metacarpal guards 20, each metacarpal guard 20 has a specific thickness and is formed on the protective surface 102 of the protection body 10, and corresponds to the posterior side of the metacarpal bone. Each metacarpal guard 20 is formed between the first short side 103 and the second short side 104 and is arranged at intervals on the imaginary center line A, and the width of each metacarpal guard 20 closer to the first short side 103 and the second short side 104 is larger than the width of the central metacarpal guard 20 of the protection body 10, and the width gradually changes. The upper and lower sides of each elastic slot 11 each have a metacarpal guard 20, and the outer peripheral upper side of each metacarpal guard 20 has a first slope 21, and the outer peripheral lower side has a second slope 22, and the first slope 21 and the second slope 22 are both located on the imaginary center line A.

The protection body 10 has a sesamoid guard 30 and a pair of sesamoid cushions 40. The sesamoid guard 30 has a specific thickness and is formed on the protective surface 102 and corresponds to the sesamoid bones of the horse leg, and is used to protect the sesamoid bones at the rear of the horse leg. The sesamoid guard 30 located on the imaginary center line A is star-shaped, having at least five points, the distance between the leftmost point and the rightmost point is greater than the width of each metacarpal guard 20, and the sesamoid guard 30 located on the imaginary center line A has a first groove 31, and the two ends of the first groove 31 are directed toward the first long side 107 and the second long side 108, respectively. The protection body 10 has a pair of hexagonal sesamoid cushions 40, the pair of sesamoid cushions 40 are formed on both sides of the sesamoid guard 30, respectively, and are used to protect the sesamoid bones on both sides of the horse leg, and each sesamoid cushion 40 has a second groove 41, the second groove 41 is V-shaped, and one end of the second groove 41 faces the opening of the first groove 31. Sesamoid guard 30 bends more easily because of the first groove 31. Sesamoid cushion 40 is easier to bend with the movement of the horse's leg because of the V-shaped second groove 41.

Each metacarpal guard 20, each sesamoid guard 30, and each sesamoid cushion 40 are provided with a plurality of ventilation holes 50, each ventilation hole 50 is conical in shape, with a larger opening on the surface of each metacarpal guard 20 and a smaller opening on the wearing surface 101 of the protection body 10, and the wall of each ventilation hole 50 has at least four inclined planes 51.

Through the above structure, in this embodiment, the protection body 10 can be made perforated through the elastic slots 11, thereby increasing the flexibility of bending of the protection body 10. When the horse leg bends, the elastic slots 11 become narrower and the dovetail-shaped ends of the elastic slots 11 contract inward, closely fitting the contour of the horse leg, and at the same time dispersing the impact force from the outside, while when the horse leg straightens, the elastic slots 11 expand, giving the horse leg sufficient space for movement.

The metacarpal guards 20 serve as the skeleton of the protector body, providing strong protection and support. The sloped design of the metacarpal guards 20 allows the protector body to deform as the horse leg bends. When the horse leg bends to its limit, the gap between the metacarpal guards 20 decreases, causing the two slopes to abut against each other, forming a tight protective layer that effectively blocks external kicks.

The sesamoid guard 30 and the sesamoid cushions 40 are specifically designed to protect the most vulnerable sesamoid bones of the horse leg. The star-shaped design of the sesamoid guard 30 is like a sturdy shield that resists impacts from all directions, while the sesamoid cushions 40 can cushion lateral kicks to prevent damage to the sesamoid bones.

The conical ventilation holes 50 formed on each guard can effectively increase the ventilation area of the protector, allowing air to flow smoothly and improving the wearing comfort of the horse leg during exercise. The inclined walls of the conical ventilation holes 50 can accelerate air flow and quickly discharge the heat generated by the horse leg, preventing discomfort caused by overheating. The conical ventilation holes 50 can reduce the amount of material used in the protector, reducing the weight of the protector and reducing the burden on the horse leg.

Overall, the protection body dynamically adjusts with every movement of the horse leg. The combination of elastic slots 11 and various guards ensures that the protection body provides maximum protection for the horse leg while not restricting the free movement of the horse leg.

The embodiments described above are merely illustrative of the invention and are not intended to limit the invention, therefore, any changes in numerical values or substitutions of equivalent elements should still fall within the scope of the invention.

What is claimed is:

1. A horse leg protector, comprising:
A protection body having a wearing surface facing the horse leg and a protective surface facing the external space, wherein the upper side of the protection body has a first short side, the lower side of the protection body has a second short side, the first short side is inwardly recessed from the second short side to form a first recess, the first short side on both sides of the first recess forms an upper concave arc, the second short side is inwardly recessed from the first short side to form a second recess, the second short side on both sides of the second recess forms a lower concave arc, the first recess and the second recess are connected to form an imaginary center line parallel to the metacarpal bone of the horse leg, and the protection body has a first long side and a second long side on both sides respectively;
At least two elastic slots, formed on the protective surface corresponding to the posterior side of the metacarpal bone, wherein each clastic slot is formed between the first short side and the second short side, and the elastic slots are arranged at intervals on the imaginary center line, each end of each elastic slot is closed and faces the first long side and the second long side respectively, the closed end of each elastic slot is bifurcated to form two angular grooves, the two angular grooves are obliquely extended in different directions to form a dovetail shape, the middle part of each elastic slot is concave, and both ends are convex, the radius of curvature and length of the concave part of the elastic slot are larger than the radius of curvature and length of the convex part;
At least three metacarpal guards, having a specific thickness and formed on the protective surface and corresponding to the posterior side of the metacarpal bone, wherein each metacarpal guard is formed between the first short side and the second short side and arranged on the imaginary center line, the width of each metacarpal guard close to the first short side and the second short side is larger than the width of the central metacarpal guard of the protection body, and the width has a gradual change relationship, any two metacarpal guards are formed on the upper side and lower side of the elastic slot respectively, and the outer periphery of each metacarpal guard has a first slope and a second slope, the opposite side of the first slope is the second slope, and the first slope and the second slope are located on the imaginary center line;
The protection body is bent towards the direction of the protective surface, the slopes of each metacarpal guard facing the elastic slot gradually approach each other, the width of each clastic slot is gradually reduced by the compression of each metacarpal guard, and when the protection body is in the maximum bending state, the slopes of each metacarpal guard facing the elastic slot are in contact with each other.

2. The horse leg protector as claimed in claim 1, wherein each metacarpal guard is provided with a pair of ventilation holes, each ventilation hole is conical in shape, with a larger opening on the surface of the metacarpal guard and a smaller opening on the wearing surface of the protection body, and the wall of each ventilation hole has at least four inclined planes.

3. The horse leg protector as claimed in claim 1, wherein the protection body further comprises a sesamoid guard, the sesamoid guard has a specific thickness and is formed on the protective surface corresponding to the sesamoid bones of the horse leg, the sesamoid guard located on the imaginary center line is star-shaped, having at least five points, the distance between the leftmost point and the rightmost point is greater than the width of each metacarpal guard, and the sesamoid guard located on the imaginary center line has a first groove, and the two ends of the first groove are directed toward the first long side and the second long side, respectively.

4. The horse leg protector as claimed in claim 3, wherein the sesamoid guard is provided with a plurality of ventilation holes, each ventilation hole is conical in shape, with a larger opening on the surface of the sesamoid guard and a smaller opening on the wearing surface of the protection body, and the wall of each ventilation hole has at least four inclined planes.

5. The horse leg protector as claimed in claim 3, wherein the protection body further comprises a pair of sesamoid cushions, the pair of sesamoid cushions are formed on both sides of the sesamoid guard, respectively, and each sesamoid cushion has a second groove, the second groove is V-shaped, and one end of the second groove faces the opening of the first groove.
